(19) United States
(12) Patent Application Publication
(10) Pub. No.: US 2011/0093865 A1
(43) Pub. Date: Apr. 21, 2011

(54) METHODS AND SYSTEMS INVOLVING REMOTE EXCEPTION CHECKS

(75) Inventors: Michael H. Dawson, Ottawa (CA); Graeme Johnson, Ottawa (CA)

(73) Assignee: INTERNATIONAL BUSINESS MACHINES CORPORATION, Armonk, NY (US)

(21) Appl. No.: 12/887,061

(22) Filed: Sep. 21, 2010

(30) Foreign Application Priority Data
Oct. 16, 2009 (CA) 2680596

(51) Int. Cl. G06F 9/46; G06F 13/00

(52) U.S. Cl. 719/313

(57) ABSTRACT

A method includes receiving a remote call from a native process in a Java virtual process; and sending a return call to the native process, wherein the return call includes an exception status of the Java virtual process.

### CROSS REFERENCE TO RELATED APPLICATIONS

This application claims benefit of priority of Foreign Patent Application No. CA 2680596, filed in Canada on Oct. 16, 2009, which is herein incorporated by reference.

### BACKGROUND OF THE INVENTION

### Field of the Invention

The present invention relates to Java virtual machines, and more specifically, to the interaction of different machines or processes operating Java and native code. Java™ is a trademark of Sun Microsystems, Inc. in the United States, other countries, or both

A method and system that increases the efficiency of communications between processes using Java and native code is desired.

### SUMMARY OF THE INVENTION

According to one embodiment of the present invention, a method includes receiving a remote call from a native process in a Java virtual process; and sending a return call to the native process, wherein the return call includes an exception status of the Java virtual process.

According to another embodiment of the present invention a method includes determining whether an interrupt is posted on a first thread in a Java virtual machine, sending a remote call to a native process that indicates that an exception has occurred in the first thread responsive to determining that an interrupt is posted on the first thread in the Java virtual machine, and updating a second thread in the native process with the exception, wherein the second thread is associated with the first thread.

According to yet another embodiment of the present invention a system includes a processor operative to receive a remote call from a native process in a Java virtual machine process, and send a return call to the native process, wherein the return call includes an exception status of the Java virtual machine process.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 illustrates a prior art example of a Java virtual machine;

FIG. 2 is a block diagram of a distributed Java virtual machine;

FIG. 3 is a diagram of the prior art method;

FIG. 4 is a diagram of a synchronous method for handling exceptions;

FIG. 5 is a block diagram of an asynchronous method for handling exceptions; and

FIG. 6 is an exemplary embodiment of a system.

### DETAILED DESCRIPTION OF THE PREFERRED EMBODIMENT

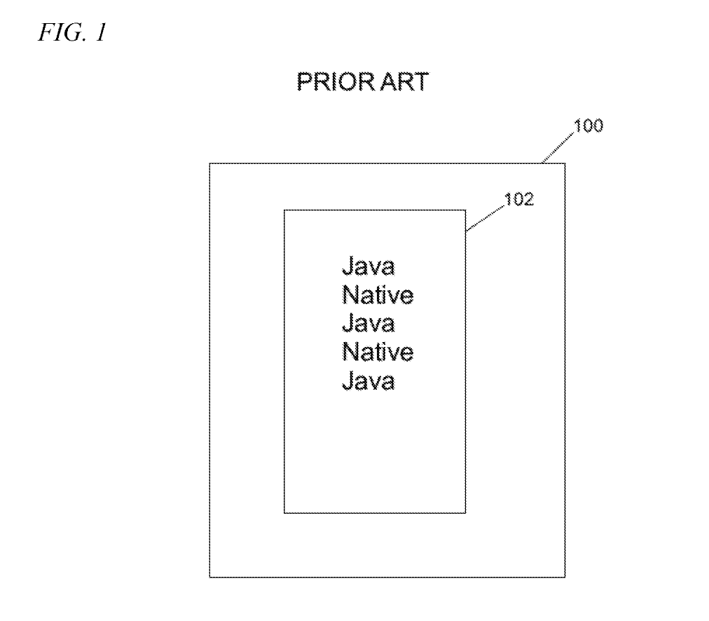

Java virtual machine (JVM) implementations support the Java native interface (JNI) as a mechanism which allows Java code to call methods written in native code, for example, C and C++ programming language and native code to call Java code methods. FIG. 1 illustrates a prior art example of a JVM 100 performing a process 102. The process executes Java and native code in the same thread. The execution process transitions execution between the Java and native code.

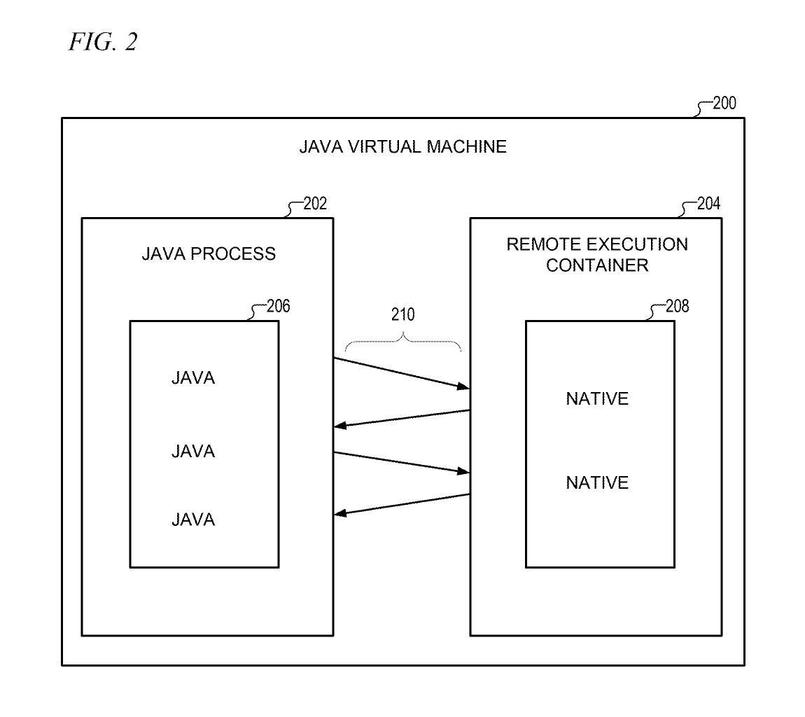

FIG. 2 illustrates a block diagram of a distributed JVM 200. The JVM 200 includes a Java process 202 and a remote execution container (REC) 204. The Java process 202 executes Java code 206, and the REC 204 executes native code 208 using calls 210 between the Java process 202 and the REC 204. The native code 208 may be, for example, hosted in separate process on one or more machines that may be separate from the machine that executes the Java code 206. The separation enables the running of the native code 208 in a different environment, for example, security context or bitwidth (e.g., 32, 64) than the JVM. The separation also mitigates the effects of misbehaved native code from destabilizing the JVM. One drawback of the JVM 200 is the latency and overhead used in the calls between the Java code 206 and the native code 208.

In previous systems, natives use JNI methods to interact with the JVM. Many of the JNI methods signal error conditions by setting an exception flag on the calling thread that is checked explicitly by the JNI native.

For example, one such JNI function is the CallStatic<Type>Method family of calls defined as: NativeType CallStatic<type>Method(JNIEnv *env, jclass,jmethodID methodID, . . . );

The family of operations invokes a static method on a Java object, according to the specified method identification (methodID). The methodID argument is obtained by calling GetStaticMethodID( ). These methods return the result of calling the Java method identified by the jmethodID. The return value does not indicate whether the call succeeded or failed, thus an additional JNI method such as “ExceptionOccurred( )” is invoked to detect an error condition. In previous systems where natives execute remotely from the JVM, the pattern uses two remote procedure calls, one to invoke the method and a subsequent call to check for exceptions.

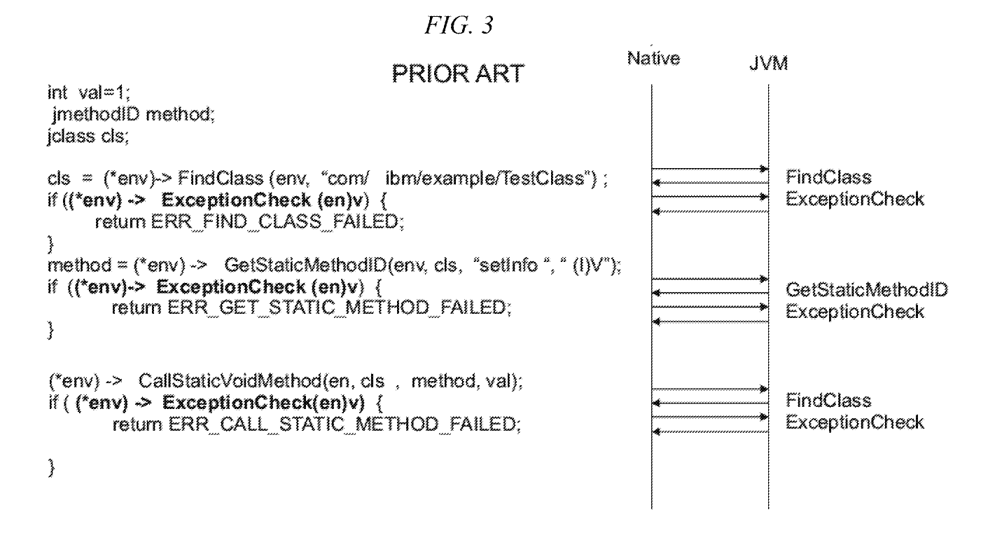

FIG. 3 illustrates a diagram of the prior art method described above; where a function such as, “FindClass” is called followed by an “ExceptionCheck” function. The arrows indicate two round trips of data for each call/error detection pair.

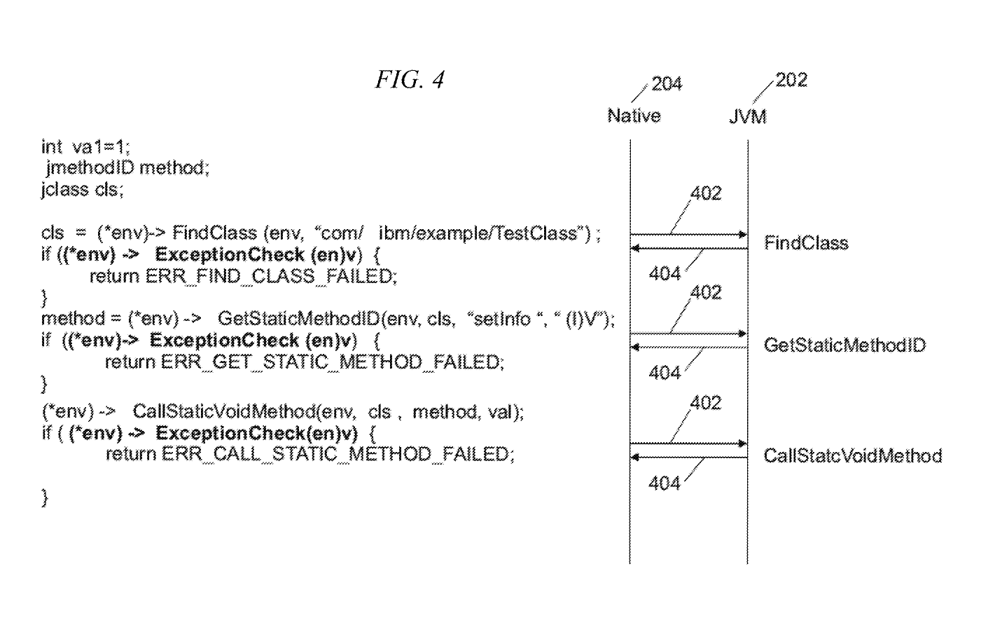

FIG. 4 illustrates a diagram of a synchronous method for handling exceptions. In the illustrated embodiment, remote calls 402 are sent from the REC 204 to the Java process 202. Return calls 404 are sent from the java process 202 to the REC 204. The return call 404 includes the exception status and/or the reference to the pending exception for each remote call 402. Including the exception status and reference to the pending exception reduces by half the number of calls and returns for each function.

There are other Java language features such as, for example, “Thread.Interrupt( )” that may asynchronously cause an exception to be posted on a thread.

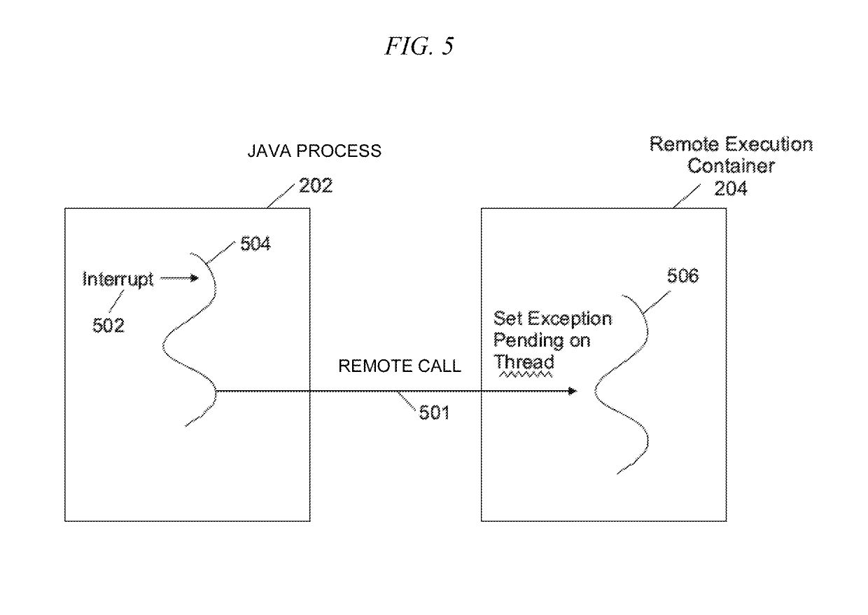

FIG. 5 illustrates a block diagram of an asynchronous method for handling exceptions. In this regard, if an interrupt 502 is posted asynchronously on a thread 504 in the Java process 202, a remote call 501 is made to the REC 204 that indicates that an exception has been raised on the thread 504. The remote call may be made from the Java process 202 without solicitation from the REC 204 in response to the interrupt posting. The remote call 501 includes a reference to the exception that updates a thread 506 (in the REC 204) with the information. Thus, the current exception status and exception for the thread, either from the information returned from the last JNI call made by the remote call 501, or through the unsolicited call made by the Java process 202 when an exception is raised asynchronously is maintained in the REC 204.

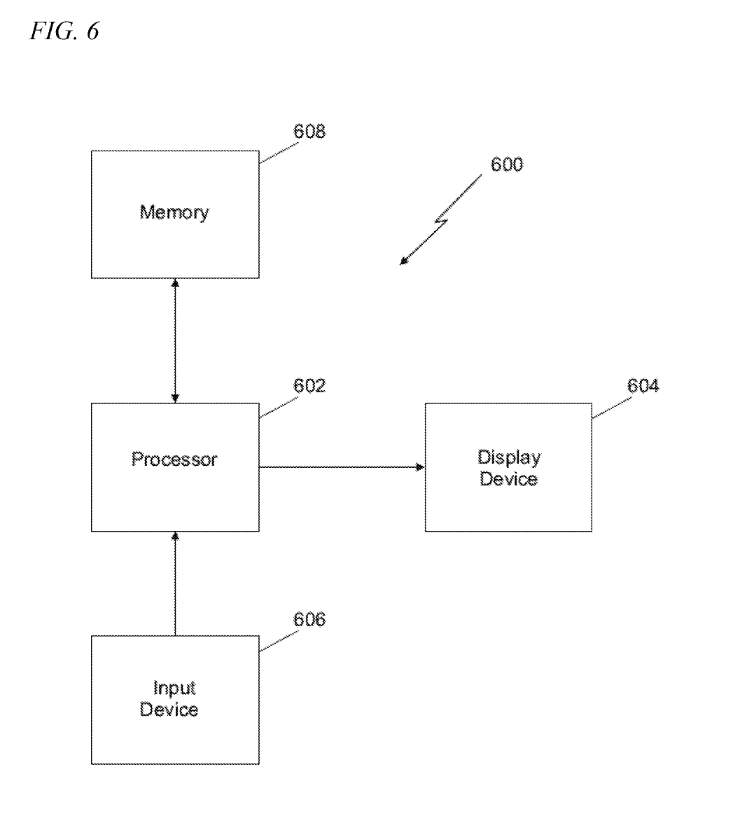

FIG. 6 illustrates a block diagram of a data processing system 600. The data processing system 600 includes a processor 602 communicative with a display device 604, an input device 606, and a memory 608. The processor 602 is operative to perform the methods described above.

Example embodiments of the present invention may be implemented, in software, for example, as any suitable computer program. For example, a program in accordance with one or more example embodiments of the present invention may be a computer program product causing a computer to execute one or more of the example methods described herein: a method for simulating arbitrary software and/or unmodified code directly on a host processor.

The computer program product may include a computer-readable medium having computer program logic or code portions embodied thereon for enabling a processor of the apparatus to perform one or more functions in accordance with one or more of the example methodologies described above. The computer program logic may thus cause the processor to perform one or more of the example methodologies, or one or more functions of a given methodology described herein.

The computer-readable storage medium may be a built-in medium installed inside a computer main body or removable medium arranged so that it can be separated from the computer main body. Examples of the built-in medium include, but are not limited to, rewriteable non-volatile memories, such as RAMs, ROMs, flash memories, and hard disks. Examples of a removable medium may include, but are not limited to, optical storage media such as CD-ROMs and DVDs; magneto-optical storage media such as MOs; magnetism storage media such as floppy disks (trademark), cassette tapes, and removable hard disks; media with a built-in rewriteable non-volatile memory such as memory cards; and media with a built-in ROM, such as ROM cassettes.

These programs may also be provided in the form of an externally supplied propagated signal and/or a computer data signal (e.g., wireless or terrestrial) embodied in a carrier wave. The computer data signal embodying one or more instructions or functions of an example methodology may be carried on a carrier wave for transmission and/or reception by an entity that executes the instructions or functions of the example methodology. For example, the functions or instructions of the example embodiments may be implemented by processing one or more code segments of the carrier wave, for example, in a computer, where instructions or functions may be executed for simulating arbitrary software and/or unmodified code directly on a host processor, in accordance with example embodiments of the present invention.

Further, such programs, when recorded on computer-readable storage media, may be readily stored and distributed. The storage medium, as it is read by a computer, may enable the simulation of arbitrary software and/or unmodified code directly on a host processor, in accordance with the example embodiments of the present invention.

Example embodiments of the present invention being thus described, it will be obvious that the same may be varied in many ways. For example, the methods according to example embodiments of the present invention may be implemented in hardware and/or software. The hardware/software implementations may include a combination of processor(s) and article(s) of manufacture. The article(s) of manufacture may further include storage media and executable computer program(s), for example, a computer program product stored on a computer readable medium.

Although example embodiments of the present invention have been discussed herein with regard to specific applications and/or implementations, it will be understood that example embodiments may be utilized in, for example, in firm ASIC chip design or implemented in traditional circuitry.

Although example embodiments of the present invention have been shown and described with regard to certain operations being performed serially or consecutively, it will be understood that any combination of these operations may be performed simultaneously and in parallel.

Although specific aspects may be associated with specific example embodiments of the present invention, as described herein, it will be understood that the aspects of the example embodiments, as described herein, may be combined in any suitable manner.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated

The flow diagrams depicted herein are just one example. There may be many variations to this diagram or the steps (or operations) described therein without departing from the spirit of the invention. For instance, the steps may be performed in a differing order or steps may be added, deleted or modified. All of these variations are considered a part of the claimed invention.

While the preferred embodiment to the invention had been described, it will be understood that those skilled in the art, both now and in the future, may make various improvements and enhancements, which fall within the scope of the claims, which follow. These claims should be construed to maintain the proper protection for the invention first described.

What is claimed is:

1. A computer implemented method comprising:
receiving a remote call from a native process in a Java virtual process; and
sending a return call to the native process, wherein the return call includes an exception status of the Java virtual process.

2. The computer implemented method of claim 1, wherein the return call further includes a reference to the exception.

3. The computer implemented method of claim 1, wherein the return call and the exception status are sent in a single transmission.

4. The computer implemented method of claim 1, wherein the native process is a C programming language process.

5. The computer implemented method of claim 1, wherein the native process is performed in a remote execution container.

6. A computer program product for handling remote calls, the computer program product comprising:
computer readable program code configured to receive a remote call from a native process in a Java virtual process, wherein the native process is a C programming language process performed in a remote execution container; and
computer readable program code configured to send a return call to the native process, wherein the return call includes an exception status of the Java virtual process, wherein the return call further includes a reference to the exception, and wherein the return call and the exception status are sent in a single transmission.

7. A computer implemented method comprising:
determining whether an interrupt is posted on a first thread in a Java virtual machine;
sending a remote call to a native process that indicates that an exception has occurred in the first thread responsive to determining that an interrupt is posted on the first thread in the Java virtual machine; and
updating a second thread in the native process with the exception, wherein the second thread is associated with the first thread.

8. The computer implemented method of claim 7, wherein the remote call includes a reference to the exception.

9. The computer implemented method of claim 7, wherein the native process is a C programming language process.

10. The computer implemented method of claim 7, wherein the native process is a programming language process.

11. The computer implemented method of claim 7, wherein the native process is performed in a remote execution container.

12. A computer program product comprising:
computer readable program code configured to determine whether an interrupt is posted on a first thread in a Java virtual machine;
computer readable program code configured to send a remote call to a native process that indicates that an exception has occurred in the first thread responsive to determining that an interrupt is posted on the first thread in the Java virtual machine; and
computer readable program code configured to update a second thread in the native process with the exception, wherein the second thread is associated with the first thread.

13. A system comprising a processor operative to receive a remote call from a native process in a Java virtual machine process, and send a return call to the native process, wherein the return call includes an exception status of the Java virtual process.

14. The system of claim 13, wherein the return call further includes a reference to the exception.

15. The system of claim 13, wherein the return call and the exception status are sent in a single transmission.

16. The system of claim 13, wherein the native process is a C programming language process.

17. The system of claim 13, wherein the native process is a programming language process.

18. The system of claim 13, wherein the native process is performed in a remote execution container.

19. The system of claim 13, wherein the processor is further operative to determine whether an interrupt is posted on a thread in a Java virtual machine, send a remote call to a native process that indicates that an exception has occurred in a first thread responsive to determining that an interrupt is posted on a thread in the Java virtual machine; and update a second thread with the exception in the native process.
